(19) United States
(12) Patent Application Publication
(10) Pub. No.: US 2026/0129065 A1
(43) Pub. Date: May 7, 2026

(54) Open Roaming Security Management

(71) Applicant: Cisco Technology, Inc., San Jose, CA (US)

(72) Inventors: Robert Barton, VANCOUVER (CA); Bhavik Pradeep Shah, BANGALORE (IN); Barry Qi Yuan, VANCOUVER (CA); Jerome Henry, Pittsboro, NC (US)

(21) Appl. No.: 18/938,038

(22) Filed: Nov. 5, 2024

(51) Int. Cl. H04L 9/40; H04L 67/50

(52) U.S. Cl. CPC H04L 63/1433; H04L 63/1416; H04L 63/145; H04L 67/535; H04L 2463/141

(57) ABSTRACT

Devices, systems, methods, and processes for enhancement of security measurement in Open Roaming network are described herein. Typically, in Open Roaming networks access nodes do not have the information whether a user device is a trusted device and accesses the network based on authentication by an Identity Provider (IdP). To address these issues, access nodes may be configured to generate a trust score for the user device based on their monitored activities on the network. The access node may share the trust score with the IdP. The IdP may receive one or more trust scores for the user device and generates a global trust score for the user device. The IdP further shares the global trust score with Identity Federation. During a re-association attempt, a new access node may grant or deny the network access to the user device based on the received global trust score of the user device.

The present disclosure relates to network access management. More particularly, the present disclosure relates to enhancement of network security especially in open roaming networks.

### BACKGROUND

Open Roaming is a cloud-based framework, promoted by Wireless Broadband Alliance (WBA), to simplify and enhance a user's Wi-Fi experience. Open Roaming aims at providing secure and seamless connectivity across different Wi-Fi networks without needing to select a network, request access, or authenticate the user's device. Identity Federations make an important part of Open Roaming and refer to the collaborative framework that allows multiple Identity Providers (IdPs) to authenticate users, thereby providing secure and seamless access to different networks.

As a user device moves from one location to another, the user device can be authenticated with the Identity Federation and granted access to the local network. However, the local network (e.g., access nodes) receives little to no information about the user device. When the user device moves from one Wi-Fi network to another Wi-Fi network, at some other location, the network usually has no information regarding a user's behavior on the network, whether the user device is known to have caused security violations or not. The user device is simply trusted because the user device is known to the Identity Federation. This may affect the security of the network.

### SUMMARY OF THE DISCLOSURE

Systems and methods for enhancement of network security especially in open roaming networks in accordance with embodiments of the disclosure are described herein.

In many embodiments, a device comprises a processor, a network interface controller configured to provide access to a network, and a memory communicatively coupled to the processor. The network interface controller is communicatively coupled to an identity provider. The memory comprises a security management logic that is configured to receive an association request from a user device, authenticate the user device with the identity provider in response to receiving the association request, grant the user device an access to the network based on the authentication, monitor one or more activities of the user device on the network, generate a local trust score for the user device based on the monitored one or more activities, and transmit the local trust score to the identity provider.

In a variety of embodiments, monitoring the one or more activities of the user device on the network comprises detecting one or more security events related to the user device.

In a number of embodiments, the one or more security events include at least one of a security violation event, a malware propagation, an unauthorized probing event, or a Distributed Denial-of-Service (DDoS) event.

In several embodiments, the security management logic is further configured to receive a new association request from the user device, and re-authenticate the user device with the identity provider in response to receiving the new association request.

In further embodiments, the security management logic is further configured to receive a global trust score of the user device from the identity provider in response to the re-authentication of the user device.

In numerous embodiments, the global trust score is based on an aggregation of the local trust score of the user device and one or more other local trust scores of the user device.

In more embodiments, the security management logic is further configured to compare the global trust score of the user device with a threshold score.

In various embodiments, the security management logic is further configured to control the user device access to the network based on the comparison of the global trust score with the threshold score.

In yet more embodiments, to control the user device access to the network, the security management logic is further configured to grant the user device restricted access to the network based on the global trust score being less than the threshold score.

In still more embodiments, to control the user device access to the network, the security management logic is further configured to deny the user device access to the network based on the global trust score being less than the threshold score.

In still yet more embodiments, the global trust score being less than the threshold score indicates that the user device has a non-compliant behavior.

In further embodiments, the security management logic is further configured to receive a warning from the identity provider based on the user device having the non-compliant behavior.

In many further embodiments, the security management logic is further configured to generate a new local trust score for the user device, and transmit the new local trust score to the identity provider, wherein the global trust score of the user device is updated based on the new local trust score.

In yet further embodiments, to control the user device access to the network, the security management logic is further configured to allow the user device access to the network based on the global trust score being greater than the threshold score.

In still further embodiments, monitoring the one or more activities of the user device on the network further comprises monitoring one or more packets transmitted and received by the user device on the network.

In several more embodiments, a device comprises a processor, a network interface controller communicatively coupled to a plurality of access nodes, and a memory communicatively coupled to the processor. The memory comprises a security management logic that is configured to authenticate a user device attempting to access a network, receive one or more local trust scores for the user device from at least one access node of the plurality of access nodes, generate a global trust score for the user device based on an aggregation of the one or more local trust scores, and share the global trust score for the user device with an identity federation.

In several additional embodiments, the device is associated with an identity provider, and wherein the identity provider and one or more other identity providers are members of the identity federation.

In numerous additional embodiments, the global trust score is shared among the members of the identity federation.

In some more embodiments, the security management logic is further configured to receive an authentication request for the user device, from another access node of the plurality of access nodes, re-authenticate the user device based on the authentication request, and transmit the global trust score of the user device to the other access node based on the re-authentication, wherein the user device access to the network is controlled based on the global trust score.

In one or more embodiments, a method for security management in open roaming is provided. The method comprises receiving an association request from a user device, authenticating the user device with an identity provider in response to receiving the association request, granting the user device an access to a network based on the authentication, monitoring one or more activities of the user device on the network, generating a local trust score for the user device based on the monitored one or more activities, and transmitting the local trust score to the identity provider.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual diagram depicting an Open Roaming Environment in accordance with various embodiments of the disclosure;

FIG. 2 is a conceptual diagram depicting sharing of trust scores within an IdF in accordance with various embodiments of the disclosure;

FIG. 3 is a conceptual diagram depicting Open Roaming with enhanced security in accordance with various embodiments of the disclosure;

FIG. 4 is a flowchart showing a process for first time local trust score generation for a user device in accordance with various embodiments of the disclosure;

FIG. 5 is a flowchart showing a process for re-association of a user device with a new access node in accordance with various embodiments of the disclosure;

FIG. 6 is a flowchart showing a process for an identity provider authenticating a user device in Open Roaming set-up in accordance with various embodiments of the disclosure;

FIG. 7 is a flowchart showing a process for updating a global trust score profile of a user device in accordance with various embodiments of the disclosure; and

FIG. 8 is a conceptual block diagram of a device suitable for configuration with a security management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide enhanced network security in Open Roaming (OR) networks. Identity Federation (IdF) in OR may refer to a collaborative framework of multiple Identity Providers (IdPs) to authenticate users across different networks seamlessly. The IdPs may be connected to access nodes (for example, Access Network Providers “ANPs”) which provide network access to user devices. Generally, OR may comprise a network the user devices connect to (e.g., a Wi-Fi hotspot network run by an ANP), one or more IdPs that authenticate the user devices and confirm to the ANP that the user devices belong to valid users, and the IdF that connects the ANP and the one or more IdPs. The IdPs may be configured to store user credentials in a cloud service. Thus, when a user device attempts to connect to an access node, an IdP may provide the user credentials and other information to the access node, so that the user device may be authenticated and can access the network.

Though the access node grants the user device access to the network based on authentication by the IdP, the access node may not have any information whether the user device is a trusted user device or has caused any security incidents during prior network connections. Security incidents may include events such as security violation event, a malware propagation, an unauthorized probing event, or a Distributed Denial-of-Service (DDoS) event. For example, the user device may have violated one or more security policies of the network, such as accessing prohibited websites, etc. Further, an access node to which the user device was connected to during the security event, has no means to inform the IdP or the IdF regarding the security event. In other words, if a user device having a history of security events connects with an access node, the access node may not have any information regarding the security events. Therefore, there is a need to report such security events locally detected by access nodes to the IdPs, and in turn to the IdF. Thus allowing the access nodes to decide whether the user device should be allowed to access the network or not.

In a variety of embodiments, an access node may receive an association request from an a user device and authenticate the user device with an IdP to provide the user device access to the network. Once the user device is successfully authenticated and has established a network connection, the access node may monitor one or more activities of the user device on the network. In other words, the access node may monitor whether the user device is involved in any security violation such as malware propagation, DDoS event, an unauthorized probing event, or the like. In an example, the user device may already be compromised by malware. Thus, when such user device connects to the access node, the malware may scan for other devices on the same network and attempt to propagate. In another example, the user device compromised by malware can perform man-in-the-middle (MITM) attacks by intercepting and altering communications between other devices and the access node. Thus, posing significant security threats to the entire network.

In more embodiments, the access node may use various tools to monitor the one or more activities of the user device connected to the network determine. Access node's security monitoring system may detect if any security events have occurred during a network session of the user device. For example, the access node may support an encrypted Visibility Engine (such as EVE® in Cisco firewall), which allows detection of malware and security related events within an encrypted packet, without the need to decrypt the packet. In another example, the access node may use an internet service provider (ISP) with in-line decryption and re-encryption capability. In further examples, security violations can be detected by wireless infrastructure. In other words, the access node may be equipped with various tools and mechanisms that determine whether the connected user device is involved in actions that violate one or more network security policies (e.g., whether the user device is a source of DDoS attack, is spreading malware, is probing other devices, etc.), or is behaving within an Acceptable Use Policy (APU).

In many embodiments, based on monitoring of the one or more activities of the user device on the network, the access node may generate a local trust score for the user device. For example, the access node may generate a local trust score of ‘5.0’ for the user device, indicating a totally compliant network session with no malicious behavior. Similarly, the access node may generate a local trust score of ‘4.0’ if the user device scanned other devices during the network session. In other words, a local trust score with a lower value than a highest local trust score value (e.g., ‘5.0’) may indicate that the user device was involved in one or more security violations. Further, the local trust score generated for the user device may decrease with an increase in the security violations. In further embodiments, the access node may transmit the local trust score of the user device to a connected IdP, for example, at the end of the network session of the user device.

In still more embodiments, the IdP may record the received local trust score of the user device and build a reputation (e.g., a user profile indicating a global trust score) for the user device over time. For example, over time, the IdP may receive one or more local trust scores of the user device from different access nodes that the user device connects to. The IdP may aggregate the received local trust scores of the user device and generate a global trust score of the user device. In some more embodiments, the IdP may share the global trust score of the user device with the IdF, for example, other IdPs within the IdF. Thus, over time the IdP, and by extension the IdF, may build user profiles of user devices indicating which user devices are involved in security events, in violation of the Acceptable Use Policy, pose a potential threat to other devices on the network, in compliance with the Acceptable Use Policy, or the like.

In still additional embodiments, when the user device attempts to re-connect to a new access node or a previously connected access node, an IdP within the IdF may be consulted for authenticating the user device and obtaining the global trust score of the user device. In response, the IdP may provide the access node with an authentication result and the global trust score of the user device, if available. In an example scenario, the global trust score provided by the IdP for the user device may be ‘4.85’, which may indicate that the user device is a trusted device. In some more embodiments, the access node may compare the received global trust score of the user device with a threshold score and may control the user device access to the network based on a comparison result. Controlling the access to the network may include granting the user device restricted access to the network based on the global trust score being less than the threshold score. For example, if the global trust score of the user device is ‘4.3’ which is slightly less than a threshold score of ‘4.5’, the access node may grant the user device restricted access to the network. Controlling the access to the network may further include denying the user device access to the network based on the global trust score being less than the threshold score. For example, if the global trust score of the user device is ‘2.8’ which is significantly less than a threshold score of ‘4.5’, the access node may deny the user device access to the network. Controlling the access to the network may further include granting the user device unrestricted access to the network based on the global trust score being greater than the threshold score. For example, if the global trust score of the user device is ‘4.8’ which is greater than the threshold score of ‘4.5’, the access node may deny the user device access to the network. Thus, the connected framework of IdF, IdPs, and access nodes having access to the updated global trust score of the user device may controls network access of the user device. In a number of embodiments, the access nodes, the IdPs, and other such network entities may not store any user information, rather share the global or local trust scores of user devices for network access and security control. Thus, ensuring that user privacy is maintained.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

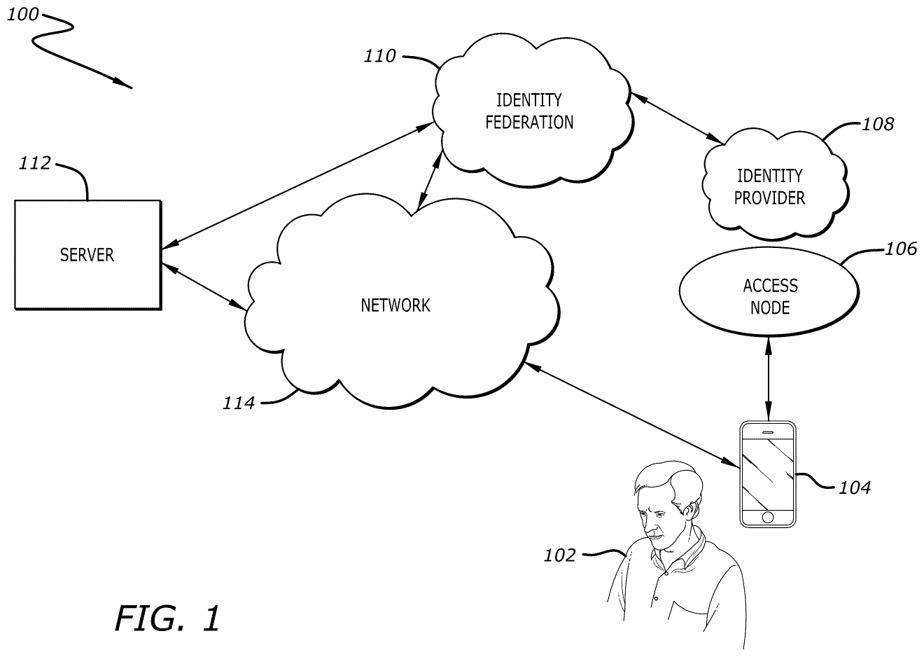

Referring to FIG. 1, a conceptual diagram 100 depicting an Open Roaming Environment in accordance with various embodiments of the disclosure is shown. The embodiments depicted in FIG. 1 may show a scenario where a user 102 may be operating a user device 104. Examples of the user device 104 may include, but are not limited to, a mobile phone, a smartphone, a tablet device, a telephone, a remote control device, a set-top box, a digital video recorder, a cable modem, a personal computer, a network computer, a mainframe, a router, an Internet-of-Things (IoT)-based device, or any other similar microcomputer-based device capable of accessing and using a Wi-Fi network or a cellular network. In a variety of embodiments, the user device 104 may be communicatively coupled to an access node 106 (for example, an access network provider “ANP”). The access node 106 may be a network node to which the user device 104 may connect to access the network (e.g., a wireless network, Internet, etc.). In many embodiments, the access node 106 may be connected to an Identity Provider (IdP) 108. The IdP 108 may be utilized to authenticate the user device 104 and provide information to the access node 106 that the user device 104 belongs to a valid user. The IdP 108 may store user's login information, credentials, trust scores, etc. in a cloud service.

In a number of embodiments, the IdP 108 may be communicatively coupled to an Identity Federation (IdF) 110. The IdF 110 may link various IdPs to provide seamless roaming and onboarding of user devices across participating Wi-Fi networks. In various embodiments, the IdF 110 may be communicatively coupled to a server 112 that may receive performance data and location data for each of the plurality of service provider Wi-Fi networks. In more embodiments, the user device 104, the IdF 110, and the server 112 may be connected to a network 114, for example, the Internet.

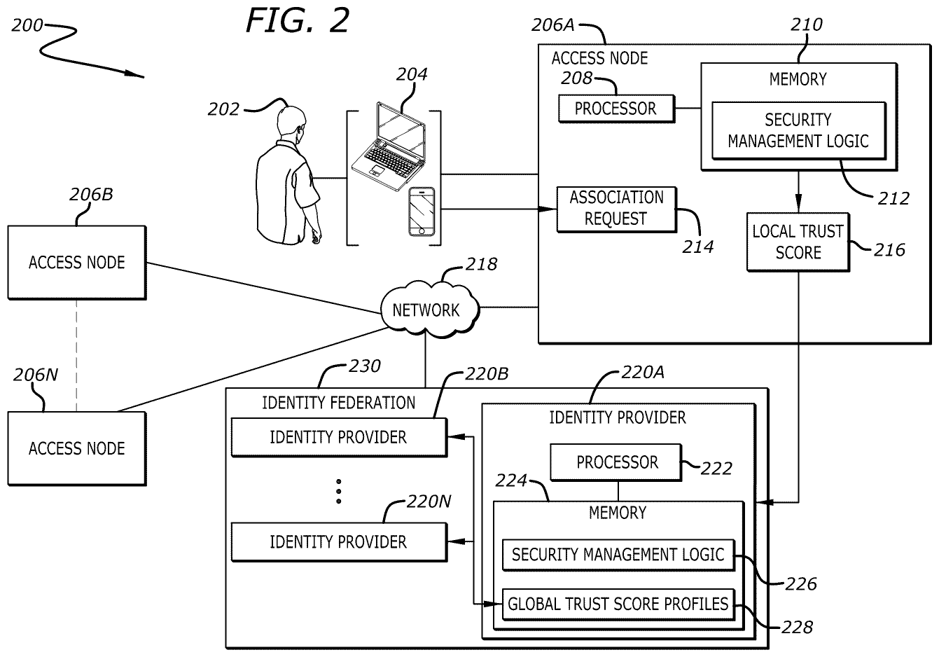

Although a specific embodiment depicting Open Roaming Environment suitable for carrying out the various steps, processes, methods, and operations described herein is discussed with respect to FIG. 1, any of a variety of systems and/or processes may be utilized in accordance with embodiments of the disclosure. In many non-limiting examples, the server 112 may work in conjunction with the IdP 108 to store user credentials, login information, user device trust scores, or other such information. The elements depicted in FIG. 1 may also be interchangeable with other elements of FIGS. 2-8 and as required to realize a particularly desired embodiment.

Referring to FIG. 2, a conceptual diagram 200 depicting sharing of trust scores within an IdF in accordance with various embodiments of the disclosure is shown. The embodiments depicted in FIG. 2 show a scenario where a user 202 may be operating a user device 204. Examples of the user device 104 may include, but are not limited to, a mobile phone, a smartphone, a tablet device, a laptop, a telephone, a remote control device, a set-top box, a digital video recorder, a cable modem, a personal computer, a network computer, a mainframe, an Internet-of-Things (IoT)-based device, a wearable device, an Augmented Reality device, or any other similar microcomputer-based device capable of accessing and using a Wi-Fi network or a cellular network. The user device 204 may also include a user interface, such as a display, a microphone, keypad, or other appropriate terminal equipment usable by the user 202. The user device 204 may include a hardware processor, memory, or circuitry configured to perform any of the functions or actions of the user device 204. For example, a software application designed using software code may be stored in the memory and executed by the processor to perform the functions of the user device 204. In several embodiments, the user device 204 may attempt to connect to one of a plurality of access nodes 206A-206N for network access. Further, the plurality of access nodes 206A-206N may be communicatively coupled to one or more IdPs 220A-222N, constituting an IdF 230.

In various embodiments, an access node 206ᵢ may include a processor 208 and a memory 210. Here, subscript “i” indicates that this configuration can be present in any access node 206A-206N. In FIG. 2, an exploded view of only one access node 206A is shown for illustrative purposes. The access node 206ᵢ may refer to any networking equipment such as a router, a switch, an access point, a server, a firewall, or the like. Examples of the processor 208 may include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), a Digital Signal Processor (DSP), or the like. The memory 210 may be communicatively coupled to the processor 208 and may store various operational parameters (such as Channel State Information (CSI), link quality, or the like) of the access node 206ᵢ, parameters of a user device session, location data, user device session history, or the like. In a number of embodiments, the memory 210 may further include a security management logic 212 configured to store various network compliance information, network security policies, threshold scores for monitoring user device behavior, or the like.

In many embodiments, an IdP 220ᵢ may include a processor 222 and a memory 224, among other internal components. Here, subscript “i” indicates that this configuration can be present in any IdP 220A-220N. In FIG. 2, an exploded view of only one IdP 220A is shown for illustrative purposes. The IdP 220ᵢ may refer to a centralized service that can verify the identities of user devices seeking access to the network 218 within Open Roaming ecosystem. The IdP 220ᵢ may be configured to securely manage user credentials and authentication protocols to enable seamless and secure access to participating networks without requiring separate login credentials for each network. Examples of the processor 222 may include, but are not limited to, an ASIC processor, a RISC processor, a CISC processor, an FPGA, a DSP, or the like. Examples of the memory may include but not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion. The memory 224 may include a security management logic 226 and global trust score profiles 228. The security management logic 226 may be configured to store various network security policies, user authentication guidelines, or the like. Each global trust score profile 228 may be created by aggregating local trust scores of a user device received from any of the plurality of access nodes 206A-206N.

In further embodiments, the one or more IdPs 220A-222N may be communicatively coupled with each other to form the IdF 230. The IdF 230 may be a collaborative framework that links the one or more IdPs 220A-222N to provide seamless roaming and onboarding of user devices (e.g., the user device 204) across participating Wi-Fi networks. The IdF 230 may enable user devices to authenticate across multiple domains or networks using a single set of credentials issued by any of the one or more IdPs 220A-222N.

In many further embodiments, the access node 206A may broadcast an identifier of the access node 206A or of the network 218. When the user device 204 moves within a service region of the access node 206A, the user device 204 may detect the broadcasted identifier of the access node 206A or the network 218. The user device 204 may then attempt to connect to the network 218 through the access node 206A. For example, the user device 204 may transmit an association request 214 to the access node 206A.

In numerous embodiments, the access node 206A may receive the association request 214 from the user device 204. The association request 214 may indicate an intent of the user 202 to access the network 218 via the user device 204. In response to receiving the association request 214 from the user device 204, the access node 206A may determine whether access should be allowed to the user device 204. For example, the access node 206A may authenticate the user device 204 before granting the user device 204 access to the network 218.

In the context of Open Roaming, the access node 206A may rely on the IdP 220A to authenticate the user device 204. For example, in response to receiving the association request, the access node 206A may initiate a communication between the IdP 220A and the user device 204 for the purpose of authentication. The IdP 220A may then authenticate the user device 204. For example, the user device 204 may provide one or more credentials to the IdP 220A and the IdP 220 may utilize the received credentials to authenticate the user device 204. The IdP 220 may further provide information (e.g., a notification, a token, etc.) to the access node 206A indicating whether the user device 204 is a valid user device or an invalid user device. In other words, the IdP 220 may serve as an intermediary between the access node 206A and the user device 204, where the trust between the IdP 220 and the access node 206A can be leveraged to also establish trust between the access node 206A and the user device 204.

In additional embodiments, the access node 206A may grant the user device 204 an access to the network 218 based on successful authentication by the IdP 220A. For the sake of ongoing description and in a non-limiting example, it is assumed that the user device 204 may have connected to any network for the first time. Thus, the IdF 230 may not have any trust information related to the user device 204 and thus may be unable to provide any trust information related to the user device 204 to the access node 206A along with the result of authentication.

In yet further embodiments, in order to build trust information of the user device 204 for future use, the access node 206A may be configured to monitor one or more activities of the user device 204 while the user device 204 is accessing the network 218. The access node 206A may monitor whether the user device 204 is behaving in accordance with network compliance and security policies, or if any malicious activity is detected. For example, the access node 206A may detect one or more security events related to the user device 204. The one or more security events may include a security violation event, a malware propagation event, an unauthorized probing event, a Distributed Denial-of-Service (DDoS) event, or other such non-compliance activities. In more embodiments, the access node 206A may use an Encrypted Visibility Engine (EVE) (e.g., Cisco® Secure Firewall) that allows for detection of malware and security related events within an encrypted packet, without the need to decrypt the packet. EVE can provide visibility into encrypted traffic without compromising confidentiality of the encrypted data. EVE can analyze encrypted traffic to detect anomalies, potential threats, and compliance issues by analyzing traffic patterns, behavior of the connected devices, metadata, or the like to detect suspicious activities. In certain embodiment, the access node 206A may also use in-line decryption and re-encryption to detect security related events.

In still further embodiments, the access node 206A may generate a local trust score 216 for the user device 204 based on the monitoring of the one or more activities during the network session. In an example scenario, if the access node 206A detects one or more violations of network security policies by the user device 204, the access node 206A may generate a lower local trust score for the user device 204. In an example, a highest value of the local trust score can be “5.0”. Thus, if the access node 206A detects violations of network security policies by the user device 204, the access node 206A may generate a local trust score ‘3.8’ that is less than the highest value of the local trust score ‘5.0”. However, if no security violations are detected and the user device 204 is determined to be behaving within an Acceptable Use Policy (APU), the access node 206A may generate the local trust score as ‘5.0’. In other words, the local trust score can be influenced by a variety of factors, for example, a number of security violations, a severity of each security violation, or the like. In several more embodiments, different security violations can have different severity indices, thus, contributing differently to the generation of the local trust score 216. In a variety of embodiments, various operations such as network session monitoring, generation of the local trust score 216, and sharing the local trust score 216 with the IdP 220A can be executed by the security management logic 212.

In still additional embodiments, the access node 206A may share the local trust score 216 of the user device 204 with the IdP 220A that may be communicatively coupled with the access node 206A. As the user device 204 had connected to any network for the first time, prior to receiving the local trust score of the user device 204 from the access node 206A, the IdP 220A may not have any trust information related to the user device 204. Thus, the IdP 220A may create a new global trust score profile for the user device 204. The new global trust score profile can be created based on the received local trust score 216 of the user device 204 from the access node 206A. In other words, the new global trust score profile can be created by aggregating local trust scores of the user device 204 received from the one or more access nodes 206A-206N. The IdP 220A may then store the new global trust score profile of the user device 204 in the global trust profiles 228. The global trust profiles 228 may include a global trust score for each user device that may have accessed the network through any of the access nodes 206A-206N.

In still more embodiments, the IdP 220A may share the global trust profiles 228 of user devices with the IdF 230. Thus, all the IdPs (e.g., the one or more IdPs 220A-220N) associated with the IdF 230 may share the global trust profiles 228 of various user devices having accessed the network via the plurality of access nodes 206A-206N.

In yet more embodiments, over time, the user device 204 may connect with the plurality of access nodes 206A-206N multiple times to access the network 218. Prior to granting network access to authenticated user device 204, the IdP 220A may provide the global trust score of the user device 204 to corresponding access node (e.g., any of the plurality of access nodes 206A-206N). The corresponding access node can control the user device 204 access to the network 218 based on the received global trust score. Controlling the access to the network 218 may include granting the user device 204 unrestricted access to the network 218, granting the user device 204 restricted or limited access to the network 218, or denying the user device 204 access to the network 218.

In a case where the access node grants the user device 204 access to the network 218, the access node further monitors the network session of the user device 204 and generates a new local trust score for the user device 204. The new local trust score is shared with the IdP 220A, which then updates the global trust score of the user device 204 based on the new local trust score. Thus, over time, the global trust score of the user device 204 gets updated. In other words, activities performed by the user device 204 in every network session can have a positive or negative impact on the global trust score of the user device 204. Since every IdP in the IdF 230 has access to the global trust score of the user device 204, the plurality of access nodes 206A - 206N are privy to trust information related to the user device 204. Thus, improving an overall security of the network 218. In further additional embodiments, various operations such creating the global trust score profiles 228, updating the global trust scores, sharing the global trust scores within the IdF 230, or the like can be executed by the security management logic 226.

Although a specific embodiment depicting sharing of a trust score within IdF suitable for carrying out the various steps, processes, methods, and operations described herein is discussed with respect to FIG. 2, any of a variety of systems and/or processes may be utilized in accordance with embodiments of the disclosure. In many additional embodiments, the user device 204 may transmit an association request directly to the IdP 220A, bypassing the access node 206A. The elements depicted in FIG. 2 may also be interchangeable with other elements of FIGS. 1 and 3-8 and as required to realize a particularly desired embodiment.

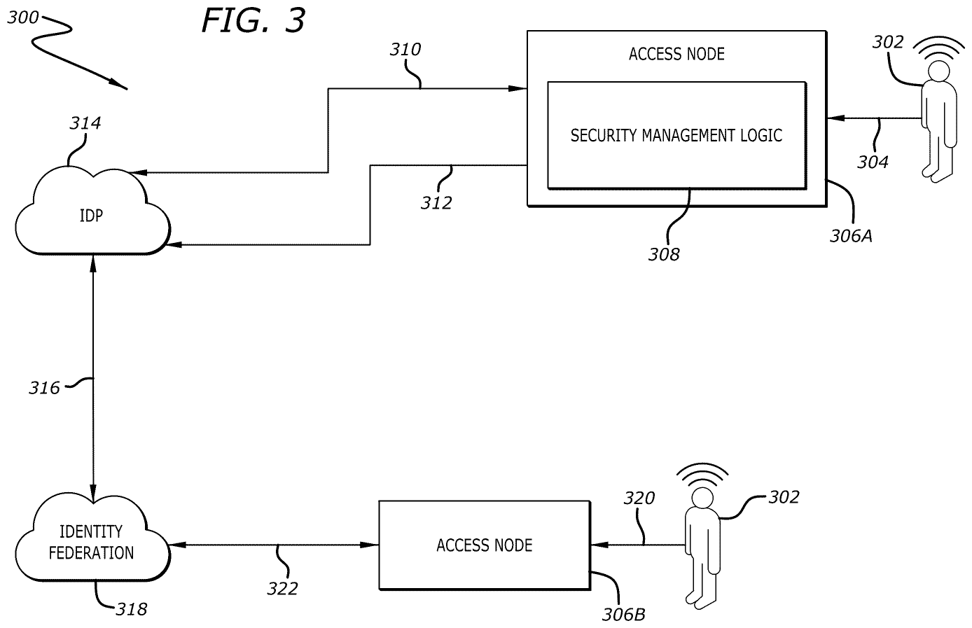

Referring to FIG. 3, a conceptual diagram 300 depicting Open Roaming with enhanced security in accordance with various embodiments of the disclosure is shown. The embodiments shown in FIG. 3 may illustrate a user device 302 initiating an association request (indicated by arrow 304) with an access node 306A. In a number of embodiments, the access node 306A may include a security management logic 308. The security management logic 308 may be configured to store various network compliance information, network security policies, threshold score for user device behavior, or the like. In more embodiments, the security management logic 308 may also be programmed to detect malware, one or more security events, non-compliant or malicious behavior by the user device 302 during a network session. In an example scenario, the security management logic 308 may use Intrusion Detection Systems (IDS), Network Traffic Analysis (NTA) to monitor traffic patterns, detect anomalous behavior or malicious behavior by the user device 302. In another example scenario, the security management logic 308 may use Machine Learning and Artificial Intelligence models to learn and identify patterns of malicious behavior, unusual patterns, or anomalies that deviate from expected or baseline behavior.

In a variety of embodiments, upon receiving the association request from the user device 302, the access node 306A may transmit an authentication request (indicated by arrow 310) to an IdP 314 for the user device 302. The IdP 314 may store user credentials, login information, etc. The IdP 314 may authenticate the user device 302 and pass authentication information (indicated by arrow 310) to the access node 306A. Based on the received authentication information for the user device 302, in several embodiments, the access node 306A may grant the user device 302 access to the network. In additional embodiments, the security management logic 308 of the access node 306A may be configured to monitor one or more activities of the user device 302 on the network. Monitoring the one or more activities may include inspecting the traffic generated by the user device 302. For example, the security management logic 308 may monitor whether the user device 302 has performed any unauthorized probing of other devices on the network, has violated one or more network security policies, conducted non-compliant behavior, or the like. In further embodiments, the security management logic 308 may generate a local trust score for the user device 302 based on the monitoring of the activities of the user device 302 on the network.

In still more embodiments, the security management logic 308 may transmit the local trust score for the user device 302 to the IdP 314 (indicated by arrow 312). The IdP 314 may be configured to generate (or update) a global trust score for the user device 302. The global trust score may be an aggregate of one or more local trust scores that the IdP 314 may have received for the user device 302 in the past and the local trust score shared by the access node 306A for the latest network session of the user device 302. In still further embodiments, the IdP 314 may share the generated or updated global trust score of the user device 302 with an IdF 318 (indicated by arrow 316). The IdF 318 may include a plurality of IdPs and access nodes to provide seamless connectivity to user devices as per the Open Roaming scheme.

In still additional embodiments, the IdP 314, and in turn the IdF 318, may build a profile for the user device 302. For example, the IdP 314 and the IdF 318 may store information such as which user devices are involved in non-compliant behavior, one or more security events, malicious activity, or are in violation of acceptable use policy. Similarly, the IdP 314 and the IdF 318 may store information regarding users that access the network in compliance with all the policies. In further additional embodiments, the IdP 314 and the IdF 318 may build the profile of the user device 302 in the form of global trust scores.

In yet more embodiments, the user device 302 may move from a location of the access node 306A to another location with a new access node 306B. The user device 302 may transmit an association request (indicated by arrow 320 to the access node 306B. The access node 306A and the access node 306B may be part of Open Roaming configuration, and thus, may be connected by the IdF 318. In still yet more embodiments, the access node 306B may transmit a request (indicated by arrow 322) to a connected IdP of the IdF 318 for authentication of the user device 302. In many further embodiments, the IdF 318 may provide the global trust score of the user device 302 to the access node 306A along with an authentication result (indicated by arrow 322).

In many additional embodiments, the access node 306B may compare the global trust score of the user device 302 with a threshold score. The threshold score may be programmed as security management logic of the access node 306B. Based on the comparison of the global trust score of the user device 302 with the threshold score, the access node 306B may control the network access of the user device 302. For example, if the global trust score of the user device 302 is 5.0 which is greater than the threshold score ‘4.6’, indicating a compliant user, the security management logic 308 may grant network access to the user device 302. However, if the received global trust score is 2.98 which is significantly less than the threshold score ‘4.6’, the security management logic 308 may deny the user device 302 access to the network. In still yet further embodiments, if the access node 306B grants the user device 302 access to the network based on the comparison of the global trust score with the threshold score, the access node 306B may further monitor the activities of the user device 302 during the network session. The access node 306B may then generate a new local trust score for the network session of the user device 302 and transmit the new local trust score to the nearest IdP. In still yet additional embodiments, the nearest IdP may update the global trust score of the user device 302 based on the new local trust score (e.g., increase, decrease, or retain the existing global trust score based on the new local trust score). The updated global trust score of the user device 302 may be share again within the IdF 318, so that all IdPs within the IdF 318 have the updated global trust score of the user device 302.

Although a specific embodiment depicting Open Roaming with enhanced security suitable for carrying out the various steps, processes, methods, and operations described herein is discussed with respect to FIG. 3, any of a variety of systems and/or processes may be utilized in accordance with embodiments of the disclosure. In numerous more embodiments, the access node 306A or the access node 306B may share the local trust score of the user device 302 with a nearest IdP via Remote Authentication Dial-In User Service (RADIUS) attributes. RADIUS refers to a networking protocol that provides centralized Authentication, Authorization, and Accounting (AAA) management for users who connect and use a network service. The elements depicted in FIG. 3 may also be interchangeable with other elements of FIGS. 1-2 and 4-8 and as required to realize a particularly desired embodiment.

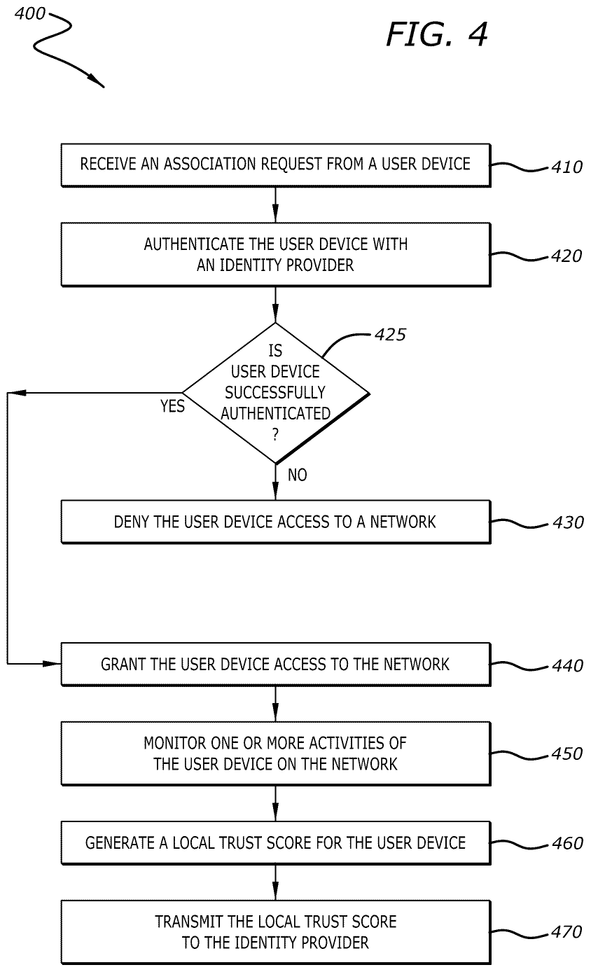

Referring to FIG. 4, a flowchart showing a process 400 for first time local trust score generation for a user device in accordance with various embodiments of the disclosure is shown. In many embodiments, the process 400 may receive an association request from a user device (block 410). The association request may include information that identifies the user device, for example, the user device identifier, Media Access Control (MAC) address, or other such information. In a variety of embodiments, the process 400 may be implemented at an access node that receives the association request from the user device.

In a number of embodiments, the process 400 may authenticate the user device with an identity provider (block 420). In response to the association request, the process 400 may attempt to authenticate the user device. The process 400 may, therefore, transmit a request to the identity provider to authenticate the user device. The identity provider may store user credentials, login information, etc. which are used to authenticate the user device.

In various embodiments, the process 400 may determine whether the user device is successfully authenticated or not (block 425). The process 400 may determine if the identity provider has successfully authenticated the user device based on the stored credentials. If the user device is not successfully authenticated, in more embodiments, the process 400 may deny the user device access to the network (block 430). In other words, the process 400 may prevent the user device from connecting to the network. For example, the process 400 may block a MAC address or an Internet protocol (IP) address of the user device. In further examples, the process 400 may set various rules or policies such as an access control list that blocks the MAC address or the IP address of the user device.

However, in additional embodiments, if the user device is successfully authenticated, the process 400 may grant the user device access to the network (block 440). The user device may thus be able to access the network and perform one or more activities on the internet, such as accessing emails, websites, using chat applications, social media, or the like.

In further embodiments, the process 400 may monitor the one or more activities of the user device on the network (block 450). For example, the process 400 may monitor whether the user device has accessed prohibited content on the network. In another example, the process 400 may monitor if the user device has performed any unauthorized probing of other devices on the network, initiated a DDoS attack, initiated a malware propagation over the network, and other such activities. In still further embodiments, the process 400 may have a security monitoring system as part of the access node to monitor the one or more activities of the user device. The security monitoring system may include monitoring toolset, programming logic, or machine learning models to analyze network traffic pattern and detect any anomalous behavior by the user device.

In still more embodiments, the process 400 may generate a local trust score for the user device (block 460). The process 400 may generate the local trust score for the user device based on the monitored one or more activities of the user device. If the process 400 detects one or more violation of network security policies, one or more security events by the user device, the process 400 may generate a lower local trust score for the user device than the highest allowed local trust score. For example, the highest allowed local trust can be ‘5.0’. Thus, if the user device was determined to be involved in unauthorized activities during the network session, the process 400 may generate the local trust score that is less than ‘5.0’. However, a local trust score of 5.0 may indicate a totally compliant user device with no malicious behavior. In various embodiments, the local trust score can be influenced by a variety of factors, for example, a number of security violations, a severity of each security violation, or the like. In several embodiments, different security violations can have different severity indices, thus, contributing differently to the generation of the local trust score.

In still further embodiments, the process 400 may transmit the local trust score to the identity provider (block 470). The process 400 may transmit the local trust score to the identity provider. In various further embodiments, the identity provider may store the local trust score of the user device in the form of a user profile (e.g., a global trust score) indicating whether the user device is a compliant or a non-compliant user device. In still additional embodiments, the process 400 may enable the identity provider to share the global trust score of the user device with an identity federation that the identity provider is a member of.

Although a specific embodiment for first time local trust score generation for a user device suitable for carrying out the various steps, processes, methods, and operations described herein is discussed with respect to FIG. 4, any of a variety of systems and/or processes may be utilized in accordance with embodiments of the disclosure. In still yet further embodiments, the process 400 may provide a restricted access of the network to the user device based on the determination that the user device is authenticated with special condition by the identity provider. For example, the identity provider may pass the information to the access node that the user device has past history of accessing the prohibited content on the network, and therefore, may only be granted limited access of the network. The elements depicted in FIG. 4 may also be interchangeable with other elements of FIGS. 1-3 and 5-8 and as required to realize a particularly desired embodiment.

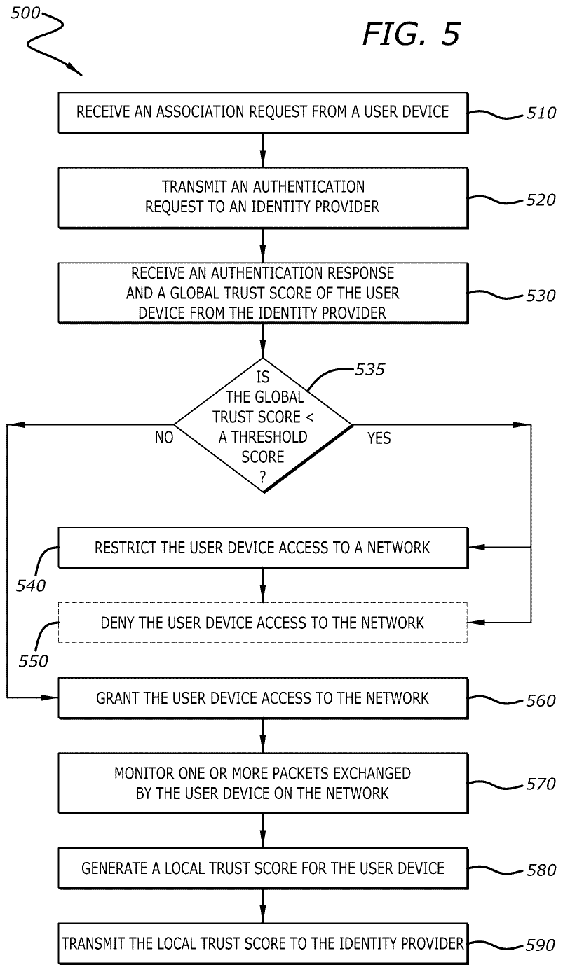

Referring to FIG. 5, a flowchart showing a process 500 for re-association of a user device with a new access node in accordance with various embodiments of the disclosure is shown. In many embodiments, the process 500 may receive an association request from a user device (block 510). The association request may include information that identifies the user device. In a number of embodiments, the user device may want to switch connection from one access node to another access node, where both the access nodes may be the part of an Open Roaming network.

In a variety of embodiments, the process 500 may transmit an authentication request to an identity provider (block 520). In response to the association request, the process 500 may attempt to authenticate the user device. The process 500 may, therefore, transmit a request to a nearby identity provider to authenticate the user device. In yet various embodiments, the user device may have previously connected with the access node. In such a scenario, the process 500 may transmit the authentication request to the identity provider to re-authenticate the user device with the identity provider in response to receiving the new association request.

In various embodiments, the process 500 may receive an authentication response and a global trust score of the user device from the identity provider (block 530). For example, in past, the identity provider may have received one or more local trust scores of the user device from various access nodes. The identity provider may have aggregated the local trust scores of the user device to generate the global trust score. Thus, in response to receiving the authentication request, the identity provider may transmit the authentication response (or re-authentication response) and the global trust score of the user device.

In additional embodiments, the process 500 may determine whether the global trust score is less than a threshold score (block 535). The threshold score may be a predefined numerical value that determines whether a user device should be granted or denied access to the network. To determine whether the global trust score is less than the threshold score, the process 500 may compare the global trust score with the threshold score. In numerous embodiments, the threshold score may be a configurable value and different access nodes may have different threshold scores. Further, there can be different threshold scores for different applications. Thus, depending on the application that the user device intends to access, a corresponding threshold score can be compared with the global trust score. For example, applications with high security requirements may have a higher threshold score than applications with low security requirements.

If the process 500 determines that the global trust score of the user device is less than the threshold score, in further embodiments, the process 500 may deny the user device access to the network (block 540). In an example scenario, if the global trust score of the user device is 2.5 and the threshold score is ‘4.5’, the process 500 may deny the user device access to the network. In still more embodiments, the process 500 may optionally restrict the user device access to the network (block 550). In certain scenarios, if the user device has committed a minor network compliance violation (such as accessing prohibited content on the network), the process 500 may provide a restricted access of the network to the user device. For example, the global trust score of the user device may be below the threshold score by a predefined margin. In such scenarios, the process 500 may provide a restricted access of the network to the user device.

If the process 500 determines that the global trust score of the user device is greater than the threshold score, in still more embodiments, the process 500 may grant the user device access to the network (block 560). For example, the process 500 may have received the global trust score of the user device as ‘5.0’ indicating a compliant behavior in the past. In such scenarios, the process 500 may grant the user device complete access to the network.

In still further embodiments, the process 500 may monitor one or more packets exchanged by the user device on the network (block 570). Upon granting the user device access to the network, the process 500 may inspect the one or more packets exchanged by the user device on the network to identify any anomaly or malicious activity. The process 500 may monitor one or more security events related to the user device, such as a security violation event, a malware propagation, an unauthorized probing event, or a DDoS event.

In still additional embodiments, the process 500 may generate a local trust score for the user device (block 580). Based on the monitoring of the one or more packets exchanged by the user device on the network, the process 500 may generate a new local trust score for the user device. The new local trust score may be indicative of the behavior of the user device during the network session. If the process 500 detects one or more violation of network security policies, one or more security events by the user device, the process 500 may generate a lower local trust score for the user device than the highest allowed local trust score. In various embodiments, the local trust score can be influenced by a variety of factors, for example, a number of security violations, a severity of each security violation, or the like. In several embodiments, different security violations can have different severity indices, thus, contributing differently to the generation of the local trust score.

In some more embodiments, the process 500 may transmit the new local trust score to the identity provider (block 590). The process 500 may transmit the generated local trust score to the identity provider in order to update the global trust score of the user device. More specifically, each time the user device establishes a connection to access the network, the process 500 monitors the established connection to generate a new local trust score. This local trust score may then be aggregated with the existing global trust score of the user device to generate a new global trust score at the identity provider.

Although a specific embodiment for re-association of a user device with a new access node suitable for carrying out the various steps, processes, methods, and operations described herein is discussed with respect to FIG. 5, any of a variety of systems and/or processes may be utilized in accordance with embodiments of the disclosure. In many further embodiments, the process 500 may receive a warning from the identity provider along with the global trust score. The warning may be provided to alert the process 500 regarding a user device with consistent malicious activity. The elements depicted in FIG. 5 may also be interchangeable with other elements of FIGS. 1-4 and 6-8 and as required to realize a particularly desired embodiment.

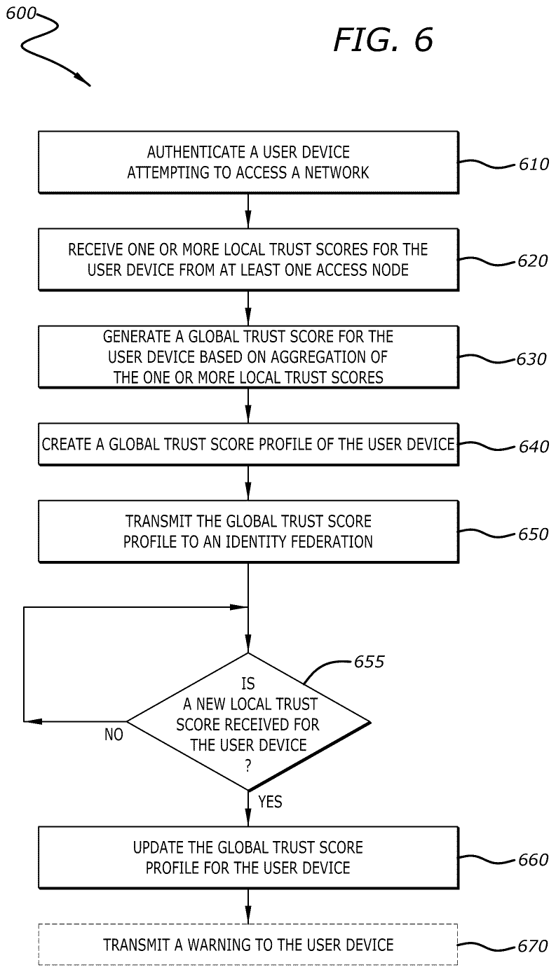

Referring to FIG. 6, a flowchart showing a process 600 for an identity provider authenticating a user device in Open Roaming set-up in accordance with various embodiments of the disclosure is shown. In many embodiments, the process 600 may authenticate a user device attempting to access a network (block 610). The process 600 may receive a request from an access node the user device attempting to connect to for accessing the network. For example, the process 600 may receive an authentication request from the access node.

In a number of embodiments, the process 600 may receive one or more local trust scores for the user device from at least one access node (block 620). A user device may access the network through one or more access nodes, where the one or more access nodes may be a part of the Open Roaming network. Every time the user device establishes a connection with an access node, the access node may monitor one or more activities of the user device during the network session and generate a local trust score for the established connection. The process 600 may thus receive the one or more local trust scores for the user device for each of the established connection.

In a variety of embodiments, the process 600 may generate a global trust score for the user device based on aggregation of the one or more local trust scores (block 630). The process 600 may aggregate the one or more local trust scores received for the user device to generate the global trust score for the user device. For example, the process 600 may receive the one or more local trust scores for the user device as ‘4.0’, ‘3.5’, ‘3.0’, and ‘2.5’ for previous four connections. Thus, the process 600 may generate the global trust score for the user device as ‘3.25’ (e.g., an average of the four trust scores). In several embodiments, the process 600 may generate the global trust score for the user device based on a weighted average of the one or more local trust scores. The weights can be assigned to the one or more local trust scores based on network session duration, a trust level associated with the access nodes, or the like. Weighting the one or more local trust scores can reduce the influence of outliers or less reliable data points, leading to a more accurate and representative aggregated score. For example, local trust cores associated with longer network session can be given more weight as compared to local trust cores associated with shorter network session, under the assumption that longer network session may provide more reliable data. Further, local trust scores from more trustworthy access nodes can be given more weight as compared to local trust scores from less trustworthy access nodes, ensuring that the aggregated global trust score reflects the most credible source.

In various embodiments, the process 600 may create a global trust score profile of the user device (block 640). Continuing the above example, the process 600 may determine that the global trust score for the user device is ‘3.25’. The process 600 may, thus, create the global trust score profile for the user device as a non-compliant or malicious user device. The profile may also indicate a risk profile for the user device, where a score of 3.25 may indicate risky behavior. Similarly, if the global trust score for the user device is 4.5, the process 600 may create the global trust profile for the user device as a compliant user device or trusted user device. In several more embodiments, the global trust score profile of the user device may indicate types of security violations that the user device was involved in. In many more embodiments, the global trust score profile may further include a trend of the global trust score of the user device. For example, a time graph visually representing the trend of global trust score over time may be stored in the global trust score profile. Such time graph may enable the process 600 in identifying recurring patterns such as improvement phases or deterioration phases over time.

In additional embodiments, the process 600 may transmit the global trust score profile to an identity federation (block 650). The process 600 may transmit the global trust score profile to the identity federation so that all the identity providers associated with the identity federation may have the global trust score profile of the user device. If the user device attempts a new connection, the nearest identity provider can determine whether to authenticate or not authenticate the user device based on the global trust score.

In further embodiments, the process 600 may determine if a new local trust score is received for the user device (block 655). If the user device establishes a new connection with an access node, the access node may monitor the one or more activities of the user device. Based on the monitored one or more activities of the user device, the access node may generate a new local trust score for the user device. The process 600 may thus receive the new local trust score from the access node.

If the new local trust score is received for the user device, in still more embodiments, the process 600 may update the global trust score profile for the user device (block 660). The new local trust score may be added to the global trust score of the user device to generate the updated global trust profile for the user device. The process 600 may further transmit the updated global trust score profile to the identity federation so that all the identity providers associated with the identity federation may have the updated global trust score profile of the user device.

In still further embodiments, the process 600 may optionally transmit a warning to the user device (block 670). The process 600 may determine that the user device may be committing a minor network security violation and may, thus, transmit a warning to the user device to stop the network security violation. For example, the process 600 may determine that the user device is accessing a prohibited content on the network. The process 600 may, therefore, transmit a warning to the user device to stop accessing the prohibited content. In further additional embodiments, the process 600 may transmit the warning to the user device at the time of authentication of the user device. Thus, alerting a user of the user device regarding falling global trust score or motivating the user to maintain compliant behavior during the upcoming network session.

Although a specific embodiment for an identity provider authenticating a user device suitable for carrying out the various steps, processes, methods, and operations described herein is discussed with respect to FIG. 6, any of a variety of systems and/or processes may be utilized in accordance with embodiments of the disclosure. In several embodiments, the process 600 may block the user device from accessing the network based on the determination that the user device is showing non-compliant behavior. The elements depicted in FIG. 6 may also be interchangeable with other elements of FIGS. 1-5 and 7-8 and as required to realize a particularly desired embodiment.

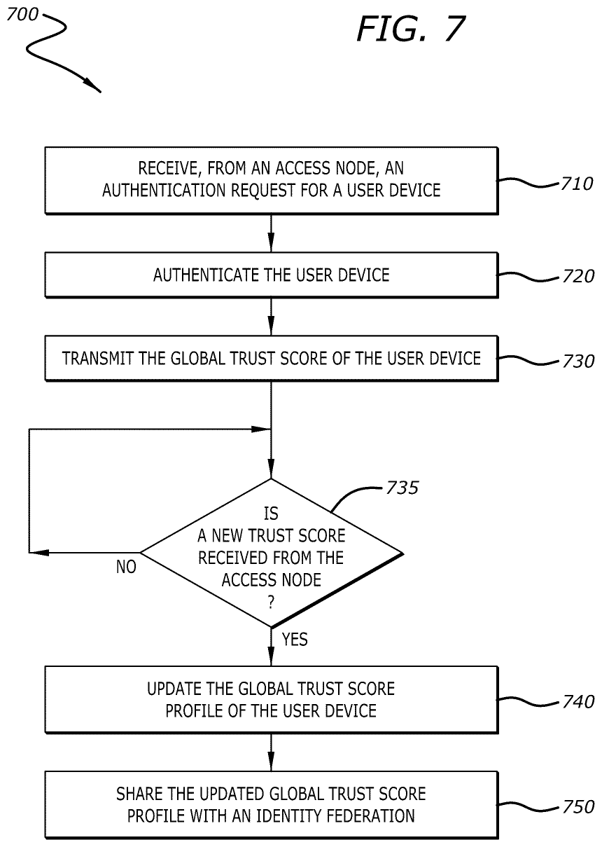

Referring to FIG. 7, a flowchart showing a process 700 for updating a global trust score profile of a user device in accordance with various embodiments of the disclosure is shown. In many embodiments, the process 700 may receive, from an access node, an authentication request for a user device (block 710). The process 700 may receive the authentication request from the access node that the user device is attempting to connect to for accessing the network. In numerous embodiments, the authentication request may include a unique identifier of the user device. In numerous additional embodiments, the process 700 may be executed at an identity provider in an Open Roaming set-up.

In a number of embodiments, the process 700 may authenticate the user device (block 720). In a variety of embodiments, the identity provider may store the user device login information, credentials, or the like in a cloud service. The process 700 may thus utilize the stored the user device login information, credentials, or the like for authenticating the user device.

In more embodiments, the process 700 may transmit a global trust score of the user device (block 730). In several embodiments, the process 700 may store the global trust score of the user device and may transmit the global trust score to the access node along with the authentication result. The global trust score may refer to an aggregate of one or more local trust scores of the user device received from at least an access node with which the user device may have connected previously. In various embodiments, the user device may be granted network access based on the global trust score.

In yet various embodiments, the process 700 may determine whether a new trust score is received from the access node (block 735). Once the connection may be established with the access node, the access node may monitor one or more activities of the user device on the network. The access node may, therefore, generate a new trust score for the user device based on the monitoring of the established connection and provide it to the process 700. The process 700 may thus determine whether the new trust score is received from the access node.

If the new trust score is received from the access node, in additional embodiments, the process 700 may update the global trust score profile of the user device (block 740). The new trust score may be aggregated with the global trust score of the user device to generate the updated global trust profile for the user device. For example, an average or a weighted average of the existing global trust score and the new trust score may be determined to update the global trust score profile. In many more embodiments, the process 700 may be configured to overwrite the updated global trust score in a memory location where the existing global trust score is stored.

In further embodiments, the process 700 may share the updated global trust score profile with an identity federation (block 750). The updated global trust score profile can be shared with all member identity providers of the identity federation. Thus, ensuring all access nodes that are associated with the identity federation has access to the updated global trust score profile of the user device via corresponding identity providers. In some more embodiments, the process 700 may continue to monitor whether a new trust score is received from the access node (block 735).

Although a specific embodiment for updating trust score profile of the user device suitable for carrying out the various steps, processes, methods, and operations described herein is discussed with respect to FIG. 7, any of a variety of systems and/or processes may be utilized in accordance with embodiments of the disclosure. In still further embodiments, the access node may transmit a warning to the user device based on detected one or more security events, so that the user device may take corrective actions. The elements depicted in FIG. 7 may also be interchangeable with other elements of FIGS. 1-6 and 8 and as required to realize a particularly desired embodiment.

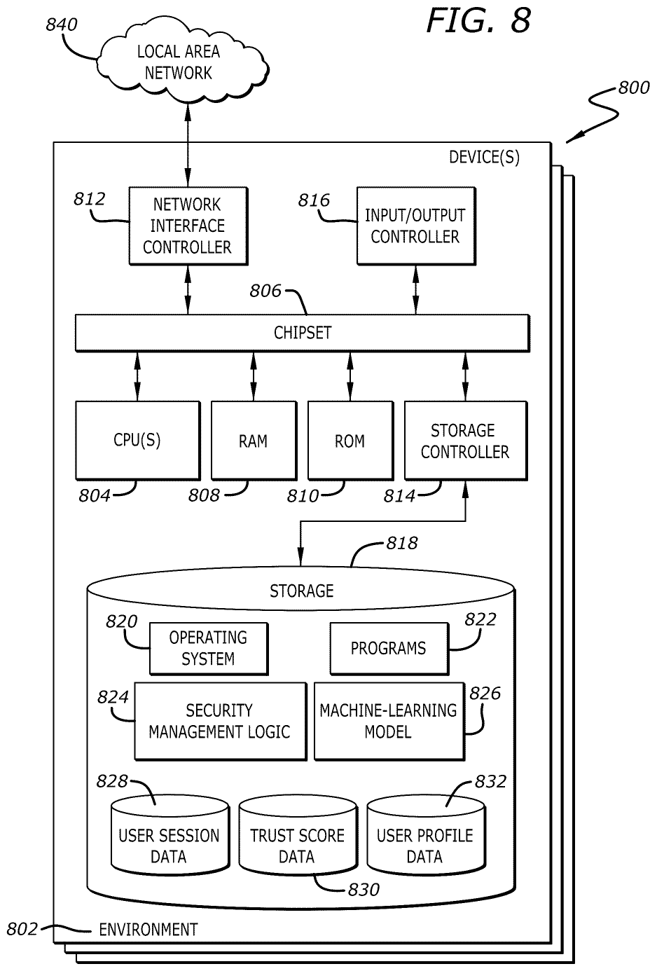

Referring to FIG. 8, a conceptual block diagram of a device 800 suitable for configuration with a security management logic in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many nonlimiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, standard programmable central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface controller (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, user session data 828, trust score data 830, and user profile data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, a RAM, a ROM, electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system 820 comprises the LINUX operating system. According to another embodiment, the operating system 820 comprises the WINDOWS® SERVER operating system from MICROSOFT Corporation of Redmond, Washington. According to further embodiments, the operating system 820 can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer executable instructions may be stored as application 822 and transform the device 800 by specifying how the processor(s) 804 can transition between states, as described above. In some embodiments, the device 800 has access to computer-readable storage media storing computer executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many further embodiments, the device 800 may include a security management logic 824. The security management logic 824 can be configured to perform one or more of the various steps, processes, operations, and/or other methods. Often, the security management logic 824 can be a set of instructions stored within a non-volatile memory that, when executed by the processor(s)/controller(s) 804 can carry out these steps, etc. In some embodiments, the security management logic 824 may be a client application that resides on a network-connected device, such as, but not limited to, a server, switch, personal or mobile computing device in a single or distributed arrangement.

In various embodiments, the security management logic 824 can be configured to perform one or more of the various steps, processes, operations, and/or other methods described above in conjunction with FIGS. 1-7 and can be configured to store various network compliance information, network security policies, threshold scores for monitoring user device behavior, or the like. The security management logic 824 can be used to monitor traffic pattern and analyze traffic generated by a connected user device to check whether the user device is behaving in a compliant manner. The security management logic 824 can also be configured to detect one or more security events related to the network connection of the user device. For example, the security management logic 824 can detect whether the user device has initiated a malware propagation, an unauthorized probing event of other devices on the network, or the like. The security management logic 824 can also be configured to compare a global trust score of the user device with threshold score to determine whether to grant or deny the network access to the user device.

In still more embodiments, the user session data 828 may store data regarding user credentials, login information, etc. In some examples, the stored credentials may be used to authenticate the user device. In further embodiments, the user session data 828 may also store historical information regarding the user device network access. In some more examples, the user session data 828 may store information regarding the access node to which the user device may have connected with, time duration of the network access, location of the access node, or the like.

In still further embodiments, the trust score data 830 stores a generated local trust score for the user device based on monitoring of the one or more activities of the user device on the network. For example, the device 800 may generate a local trust score of ‘5.0’ for the user device, indicating a totally compliant network session with no malicious behavior. Similarly, the device 800 may generate a local trust score of ‘4.0’ if the user device scanned other devices during the network session. In still several embodiments, the trust score data 803 may also store a global trust score for the user device. The global trust score may refer to an aggregated score of one or more local trust scores for the user device received for different network connections.

In still additional embodiments, the user profile data 832 may store a profile of the user device indicating the global trust score of the user device. In an example scenario, the device 800 may receive one or more local trust scores of the user device from different access nodes that the user device connects to. The device 800 may generate a global trust score of the user device based on aggregation of the one or more local trust scores of the user device. Thus, over time the device 800 may build user profiles of user devices indicating which user devices are involved in security events, in violation of the Acceptable Use Policy, pose a potential threat to other devices on the network, in compliance with the Acceptable Use Policy, or the like.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. In numerous embodiments, the ML model(s) 826 can be utilized to monitor the one or more activities of the user device on the network and identify patterns of malicious behavior, unusual patterns, or anomalies that deviate from expected or baseline behavior.

The ML model(s) 826 can be configured to generate inferences to make predictions or draw conclusions from data. An inference can be considered the output of a process of applying a model to new data. This can occur by learning from at least the user session data 828, the trust score data 830 and the user profile data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network, wherein the network interface controller is communicatively coupled to an identity provider; and
a memory communicatively coupled to the processor, wherein the memory comprises a security management logic that is configured to:
receive an association request from a user device;
authenticate the user device with the identity provider in response to receiving the association request;
grant the user device an access to the network based on the authentication;
monitor one or more activities of the user device on the network;
generate a local trust score for the user device based on the monitored one or more activities; and
transmit the local trust score to the identity provider.

2. The device of claim 1, wherein monitoring the one or more activities of the user device on the network comprises detecting one or more security events related to the user device.

3. The device of claim 2, wherein the one or more security events include at least one of a security violation event, a malware propagation, an unauthorized probing event, or a Distributed Denial-of-Service (DDoS) event.

4. The device of claim 1, wherein the security management logic is further configured to:
receive a new association request from the user device; and
re-authenticate the user device with the identity provider in response to receiving the new association request.

5. The device of claim 4, wherein the security management logic is further configured to receive a global trust score of the user device from the identity provider in response to the re-authentication of the user device.

6. The device of claim 5, wherein the global trust score is based on an aggregation of the local trust score of the user device and one or more other local trust scores of the user device.

7. The device of claim 5, wherein the security management logic is further configured to compare the global trust score of the user device with a threshold score.

8. The device of claim 7, wherein the security management logic is further configured to control the user device access to the network based on the comparison of the global trust score with the threshold score.

9. The device of claim 8, wherein to control the user device access to the network, the security management logic is further configured to grant the user device restricted access to the network based on the global trust score being less than the threshold score.

10. The device of claim 8, wherein to control the user device access to the network, the security management logic is further configured to deny the user device access to the network based on the global trust score being less than the threshold score.

11. The device of claim 8, wherein the global trust score being less than the threshold score indicates that the user device has a non-compliant behavior.

12. The device of claim 11, wherein the security management logic is further configured to receive a warning from the identity provider based on the user device having the non-compliant behavior.

13. The device of claim 12, wherein the security management logic is further configured to:
generate a new local trust score for the user device; and
transmit the new local trust score to the identity provider, wherein the global trust score of the user device is updated based on the new local trust score.

14. The device of claim 8, wherein to control the user device access to the network, the security management logic is further configured to allow the user device access to the network based on the global trust score being greater than the threshold score.

15. The device of claim 1, wherein monitoring the one or more activities of the user device on the network further comprises monitoring one or more packets transmitted and received by the user device on the network.

16. A device, comprising:
a processor;
a network interface controller communicatively coupled to a plurality of access nodes; and
a memory communicatively coupled to the processor, wherein the memory comprises a security management logic that is configured to:
authenticate a user device attempting to access a network;
receive one or more local trust scores for the user device from at least one access node of the plurality of access nodes;
generate a global trust score for the user device based on an aggregation of the one or more local trust scores; and
share the global trust score for the user device with an identity federation.

17. The device of claim 16, wherein the device is associated with an identity provider, and wherein the identity provider and one or more other identity providers are members of the identity federation.

18. The device of claim 17, wherein the global trust score is shared among the members of the identity federation.

19. The device of claim 16, wherein the security management logic is further configured to:
receive an authentication request for the user device, from another access node of the plurality of access nodes;
re-authenticate the user device based on the authentication request; and
transmit the global trust score of the user device to the other access node based on the re-authentication, wherein the user device access to the network is controlled based on the global trust score.

20. A method for security management in open roaming, comprising:
receiving an association request from a user device;
authenticating the user device with an identity provider in response to receiving the association request;
granting the user device an access to a network based on the authentication;
monitoring one or more activities of the user device on the network;
generating a local trust score for the user device based on the monitored one or more activities; and
transmitting the local trust score to the identity provider.
